(19) United States
(12) Patent Application Publication
(10) Pub. No.: US 2008/0112549 A1
(43) Pub. Date: May 15, 2008

(54) METHOD AND SYSTEM FOR PROCESSING BILLING OF INCLUDING QOS INFORMATION

(75) Inventors: Seung Hyun Yoon, Daejeon (KR); You Hyeon Jeong, Daejeon (KR); Byung Joon Lee, Daejeon (KR); Hyung Seok Chung, Daejeon (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/940,776

(22) Filed: Nov. 15, 2007

(30) Foreign Application Priority Data
Nov. 15, 2006 (KR) 10-2006-0112888

(51) Int. Cl. H04M 15/10

(52) U.S. Cl. 379/114.06

(57) ABSTRACT

A method and system for processing billing of including QoS information are provided. In the method, a call is initiated by transmitting/receiving packets directly to/from an opponent terminal after signaling with the opponent terminal using a session initiation protocol through the signaling server. Then, QoS of the call is measured while communicating with the opponent terminal. A billing process is performed of including the QoS measuring result by transmitting the QoS measuring result to the signaling server after the call established to the opponent terminal is terminated.

### CROSS-REFERENCE TO RELATED APPLICATIONS

This application claims the priority of Korean Patent Application No. 10-2006-0112888, filed on Nov. 15, 2006, in the Korean Intellectual Property Office, the disclosure of which is incorporated herein by reference.

### BACKGROUND OF THE INVENTION

1. Field of the Invention

The present invention relates to a voice over IP (VoIP) service, and more particularly, to a method and system for performing a billing process of including QoS information when a VoIP service provided through a session initiation protocol (SIP) based Internet protocol (IP).

This work was supported by the IT R&D program of MIC/IITA [2005-S-097-02, Collection Method of Billing information with QoS results at SIP based VoIP service]

2. Description of the Related Art

In general, a voice over Internet protocol (VoIP) is a technology for providing a telephone service by converting voice data to IP data packet.

A VoIP system enables more users to use an IP based telephone service at the same time through a cable than a typical telephone system. Also, the VoIP system has the superior extensibility, and the IP telephone service can be provide at much lower rate than a typical telephone service.

However, various traffics exist in an IP packet network unlike a typical telephone network. Due to such characteristics of the IP packet network, quality of service (QoS) thereof may be seriously dropped although a call is admitted.

Although the QoS in a VoIP service is seriously dropped, the VoIP service have been charged only based on call duration, which is identical to a method of charging a customer for a typical telephone service. That is, a signaling server records call duration as billing information and the VoIP service is charged based on the call duration. It is not a reasonable method of charging a customer for the VoIP service. Since there are many cases where a network provider and a VoIP service provider are different in providing a VoIP service, it was difficult to apply the QoS of the VoIP service to a billing policy.

However, it is expected that there will be a lot of efforts for securing a proper level of QoS if the VoIP telephone becomes popularized and a service level agreement (SLA) thereof becomes generalized. Therefore, it is required to introduce a billing policy that applies the quality information of a corresponding telephone service to the billing thereof.

In order to apply the QoS to the billing, technologies for indirectly measuring a network quality were introduced and have been used. However, the conventional technologies probabilistically guarantee the QoS. It is difficult to guarantee real service quality or accurately measure the real service quality using the conventional technologies.

### SUMMARY OF THE INVENTION

An aspect of the present invention provides a method and system for processing billing of including quality of service (QoS) information of a voice over IP (VoIP) service through an Internet protocol to providing a session initial protocol (SIP) based VoIP service.

Another aspect of the present invention provides a method and system for performing a billing process of including QoS information by measuring QoS at VoIP terminals, transmitting the QoS measuring result to a signaling server and recording the billing information with the QoS measuring result.

According to an aspect of the present invention, there is provided a method for processing billing of including QoS information at terminals in a system for processing billing of including QoS information that includes a plurality of terminals for a voice-call service using Internet and a signaling server for processing signaling between the terminals. In the method, call is initiated by transmitting/receiving packets directly to/from an opponent terminal after signaling with the opponent terminal using a session initiation protocol through the signaling server. Then, QoS of the call is measured while communicating with the opponent terminal. A billing process is performed based on the QoS measuring result by transmitting the QoS measuring result to the signaling server after the call established to the opponent terminal is terminated.

According to another aspect of the present invention, there is provided a method for processing billing based on QoS at a signaling server in a system for processing billing of including QoS information that includes a plurality of terminals for a voice-call service using Internet and the signaling server for processing signaling between the terminals. In the method, signaling is relayed for establishing a call among a plurality of the terminals for a voice-call service using Internet based on a session initiation protocol, and billing information is set for the call established among a plurality of the terminals. Then, a QoS measuring result, which is measured while a plurality of the terminals are communicating with each other through the established call, is received through a session initiation protocol termination message when the call is terminated. A billing is performed based on the received QoS measuring result by applying the received QoS measuring result to the billing information.

According to still another aspect of the present invention, there is provided a system for processing billing of including QoS information, including a plurality of terminals, and a signaling server. A plurality of terminals perform a VoIP service using Internet based on a session initiation protocol, measure QoS in the VoIP service while communicating with an opponent terminal, add the QoS measuring result into a session initiation protocol termination message when the VoIP service is terminated, and transmit the session initiation protocol termination message. The signaling server relays signaling for establishing a call among a plurality of the terminals, receives the QoS measuring result from a plurality of the terminals when the call is terminated, sets billing information by a call when the signaling is completed, and performs a billing process based on the received QoS measuring result by applying the received QoS measuring result to corresponding billing information.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a system for performing a billing process based on the quality of service (QoS), according to an embodiment of the present invention; and

FIG. 2 is a flowchart of a method for performing a billing process of including QoS information in a system for performing a billing process according to an embodiment of the present invention.

### DETAILED DESCRIPTION OF THE PREFERRED EMBODIMENT

Exemplary embodiments of the present invention will now be described in detail with reference to the accompanying drawings. Like numeral references denote like element throughout the accompanying drawings. In order to clearly describe the present invention, the descriptions of well-known functions and elements are omitted.

In an embodiment of the present invention, a method and system for processing billing of including QoS information will be described with a session initiation protocol (SIP) based a voice over Internet protocol (VoIP) applied thereto. At first, such a structure of a VoIP system will be described with reference to the accompanying drawings.

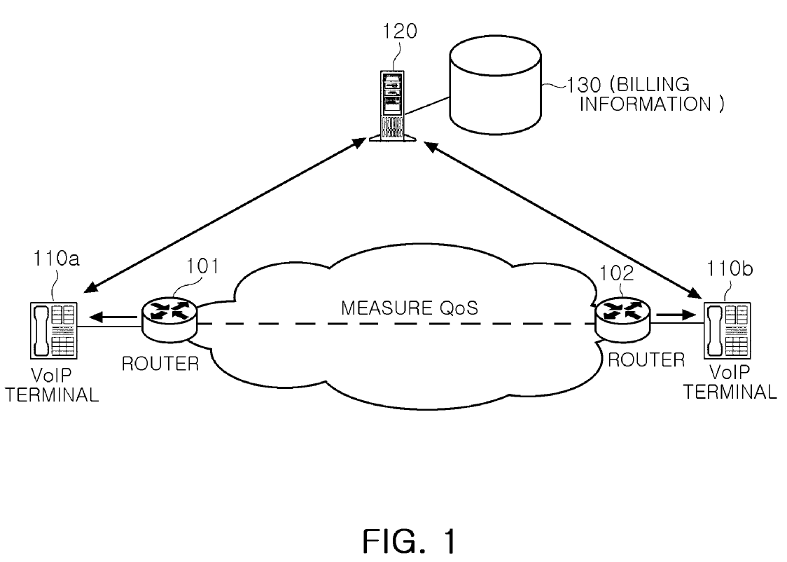

FIG. 1 is a diagram illustrating a system for performing a billing process based on QoS.

Referring to FIG. 1, the billing process system in a VoIP network includes a plurality of terminals 110a and 110b for a VoIP service, a plurality of routers 101 and 102 for transferring voice packets between the terminals 110a and 110b, a signaling server 120 for managing billing information, and a billing information database (DB) 130 for managing billing information. The billing information DB 130 may be included in the signaling server 120 or separately provided.

The terminals 110a and 110b measure QoS as soon as a VoIP service is initiated. Also, The terminals 110a and 11b transfer the QoS measuring result to the signaling server 120 when the call termination is reported. The terminals 110a and 110b control a signaling process using a SIP through the signaling server 120 for a VoIP service, and process packets that are directly transmitted to or received from an opponent terminal, thereby communicating with the opponent terminal.

The signaling server 120 receives the QoS measuring result from the terminals 110a and 110b, collects the QoS information separately for each call, and adds the collected QoS information to a call detail record (CDR) for each call. Then, the signaling server 120 writes corresponding billing information of including QoS of a corresponding call thereto to the billing information DB 130. The signaling server 120 relays signaling between the terminals 110a and 110b, for example, messages for requesting call-connection or call-termination, using the SIP, and performs call admission control (CAC) based on network resources.

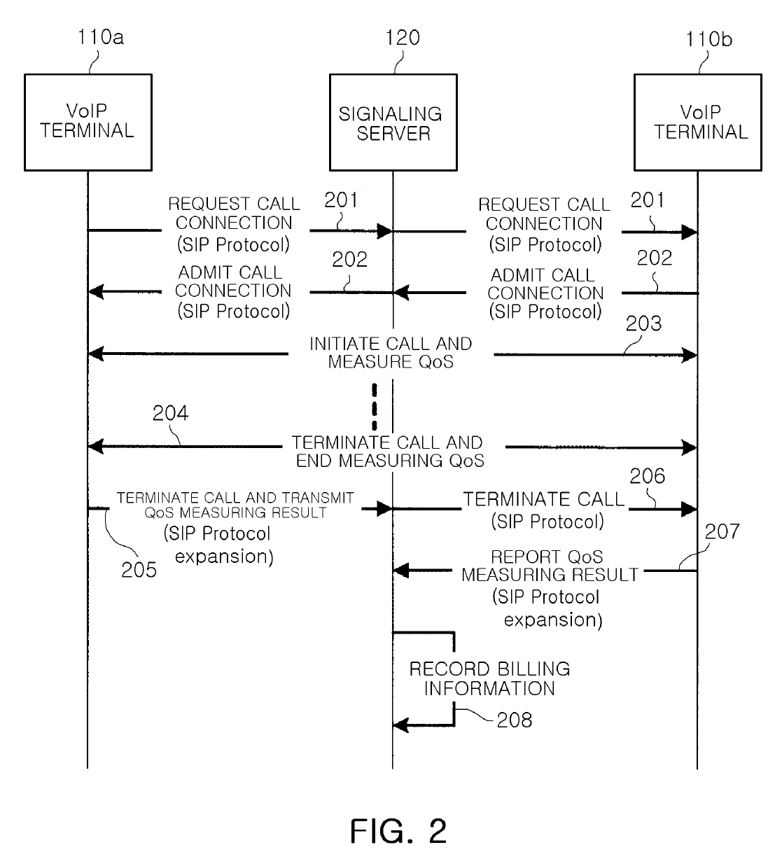

Hereinafter, a method for performing a billing process of including QoS information in a system for performing a billing process of including QoS information for providing a SIP based VoIP service according to an embodiment of the present invention will be described with reference FIG. 2.

FIG. 2 is a flowchart of a method for performing a billing process based on the quality of service (QoS) in a system for performing a billing according to an embodiment of the present invention.

Referring to FIG. 2, in operation 201, a transmitting terminal 111 transmits a message for requesting call-connection to a receiving terminal 112 through the signaling server 120 by using the SIP. In operation 202, the receiving terminal 112 admits the call-connection according to the request from the transmitting terminal 111, and transmits the message of admitting the call-connection to the transmitting terminal 111 by using the SIP.

After requesting the call-connection and admitting the call-connection, the transmitting terminal 111 begins to transmit/receive packets to/from the receiving terminal 112, directly in operation 203. The QoS thereof may vary according to a network condition.

In operation 204, the transmitting terminal 111 measures the QoS for the transmitted/received packets, such as packet delay, packet loss, and jitter. The transmitting terminal 111 can measure the QoS of a service level, and the receiving terminal 112 also can measure the QoS between the receiving terminal 112 and the transmitting terminal 111 when the call is initiated. The signaling server 120 records a time of call started.

After the call is terminated in operation 204, a party that terminates the call first among the terminals 111 and 112, for example, the receiving terminal 112, transmits a SIP termination message to the signaling server 120 to report the call-termination. The transmitting terminal 111 adds the QoS measuring result to the SIP termination message and transmits the SIP termination message to the signaling server 120 205. Then, the signaling server 120 records the call termination time according to the call termination report, and transmits a message of terminating a call to the receiving terminal 112 in operation 206. The receiving terminal terminates the call and transmits the QoS measuring result to the signaling server 120 in operation 207.

In operation 208, the signaling server 120 manages the QoS measuring results received from the terminals 111 and 112 as billing information for a corresponding call by recording the QoS measuring results with the CDR information when the CDR is recorded. That is, the signaling server 120 updates the CDR information with the billing information, and stores the updated billing information. Using the updated billing information, the signaling server 120 performs the billing process for the call of the transmitting terminal 111 based on the QoS measuring result. Herein, the CDR information is billing informing for charging a corresponding user. The CDR information includes information about a caller and call duration.

In the present embodiment, the terminal has a function of measuring the QoS when the terminal communicates with the other terminal. The QoS can be measured through total inspection, sampling inspection, and impose of test packet. Also, any known-methods for measuring the QoS can be applied.

The present invention has been shown and described in connection with the exemplary embodiments. However, the present invention is not limited thereto. That is, the method and system for processing billing of including QoS information according to an embodiment of the present invention is not limited to the VoIP service. The method and system for processing billing based on QoS according to an embodiment of the present invention can be applied to all of services requesting signaling based connection in an IP network and can be also applied to service using protocols similar to the SIP. It will be apparent to those skilled in the art that modifications and variations can be made without departing from the spirit and scope of the invention as defined by the appended claims.

As described above, the method and system for performing a billing process of including QoS information according to an embodiment of the present invention measures the quality of service for a call and adds the QoS measuring result in the billing information of the SIP based VoIP service. Therefore, a QoS based billing policy can be provided and service providers can prepare for SLA through the method and system for performing a billing process of including QoS information according to the present invention. Since customers can be reasonably charged for making calls over Internet using the method and system for performing a billing process of including QoS information according to the present invention, the VoIP service can be provided to users with a low cost while the QoS is sustained at a proper level.

What is claimed is:

1. A method for processing billing of including quality of service (QoS) information at terminals in system for processing billing of including QoS information comprising a plurality of terminals for a voice-call service using Internet and a signaling server for processing signaling between the terminals, the method comprising:
initiating a call by transmitting/receiving packets directly to/from an opponent terminal after signaling with the opponent terminal using a session initiation protocol through the signaling server;
measuring QoS of the call while communicating with the opponent terminal;
transmitting the QoS measuring result to the signaling server after the call established to the opponent terminal is terminated; and
performing a billing process of including QoS information measuring result.

2. The method of claim 1, wherein the QoS measuring result is included in a session initiation protocol termination message and transmitted to the signaling server, and the signaling server manages and applies the QoS measuring result to the billing information.

3. The method of claim 1, wherein the QoS is measured through total inspection, sampling inspection, or impose of test packets.

4. A method for processing billing of including QoS information at a signaling server in system for processing billing of including QoS information comprising a plurality of terminals for a voice-call service using Internet and the signaling server for processing signaling between the terminals, the method comprising:
relaying signaling for establishing a call among a plurality of the terminals for a voice-call service using Internet based on a session initiation protocol;
setting billing information of the call established among a plurality of the terminals;
receiving a QoS measuring result, which is measured while a plurality of the terminals are communicating with each other through the established call, through a session initiation protocol termination message when the call is terminated; and
processing billing based on the received QoS measuring result by applying the received QoS measuring result to the billing information.

5. The method of claim 4, wherein the processing of the billing comprises:
recording a call detail record (CDR) of the call;
adding the QoS measuring result in call detail record (CDR) of the call; and
applying the call detail record (CDR) having the QoS measuring result to the billing information.

6. A system for processing billing of including QoS information, comprising:
a plurality of terminals for performing a VoIP service using Internet based on a session initiation protocol, measuring QoS in the VoIP service while communicating with an opponent terminal, adding the QoS measuring result into a session initiation protocol termination message when the VoIP service is terminated, and transmitting the session initiation protocol termination message; and
a signaling server for relaying signaling for establishing a call among a plurality of the terminals, receiving the QoS measuring result from a plurality of the terminals when the call is terminated, setting billing information by a call when the signaling is completed, and performing a billing process based on the received QoS measuring result by applying the received QoS measuring result to corresponding billing information.

7. The system of claim 6, wherein the signaling server records the QoS measuring result into a call detail record (CDR) of a corresponding call when the CDR is recorded so as to apply the QoS measuring result to the billing information.

8. The system of claim 6, wherein the QoS service is measured through total inspection, sampling inspection, or impose of test packets.
